(19) United States
(12) Patent Application Publication
(10) Pub. No.: US 2015/0048625 A1
(43) Pub. Date: Feb. 19, 2015

(54) ELECTROMECHANICAL LOCK FOR CABINETS, SHOWCASES AND DRAWERS

(71) Applicants: Leo Hendrik Marie Weusten, Amsterdam (NL); Cornelis Brakband, Wezep (NL)

(72) Inventors: Leo Hendrik Marie Weusten, Amsterdam (NL); Cornelis Brakband, Wezep (NL)

(73) Assignee: Sellmore BV, Badhoevedorp (NL)

(21) Appl. No.: 14/357,000

(22) PCT Filed: Nov. 8, 2011
(86) PCT No.: PCT/EP2011/069642

§ 371 Date: Sep. 12, 2014

(51) Int. Cl. E05C 1/02; E05B 47/02

(52) U.S. Cl. CPC E05C 1/02; E05B 47/02
USPC 292/137

(57) ABSTRACT

A lock that is particularly suitable for locking cabinets, showcases and drawers includes a bolt and a housing having an opening to receive the bolt and having arranged therein a locking member for locking the bolt. The bolt comprises an bolt body, a chamfered head end and a recess part on the elongated bolt body behind the chamfered head end. The locking member is rotatably provided inside the housing and arranged to rotate between a first orientation to lock the bolt and a second orientation different from the first orientation to release the lock. The locking member comprises a bended first end that fits behind the recess part of the bolt when the locking member is rotated to the first orientation. A coil can be used to, when provided with a current, generate a magnetic force to tilt the locking member to the second orientation.

### CROSS-REFERENCE TO RELATED APPLICATION

This application is a Section 371 National Stage Application of International Application PCT/EP2011/069642 filed Nov. 8, 2011 and published as WO 2013/068036 A1 in English.

### BACKGROUND

The discussion below is merely provided for general background information and is not intended to be used as an aid in determining the scope of the claimed subject matter.

The present invention relates locks and particularly to electromechanical locks for cabinets, showcases and drawers.

To prevent a commodity from being stolen, store owners can store the commodity in a locked cabinet, showcase or drawer. An alarm can be triggered when unauthorized opening of the cabinet, showcase or drawer is detected. Typically, authorized personnel carry some sort of a key to deactivate the alarm and open the cabinet, showcase or drawer.

Electromechanical locks are known to be relatively large because of the design of the locking elements. Because of its size it is difficult to use the locks in smaller cabinets, showcases or drawers. Moreover, the locks take too much space limiting the space for the commodities to be stored.

Thus, there is a need for an improved electromechanical lock having a relatively small form factor for cabinets, showcases and drawers.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

Aspects of the invention provide for an electromechanical lock having a relatively small form factor, which is particularly but not exclusively suitable for locking cabinets, showcases and drawers.

According to an aspect of the invention a lock is proposed comprising a bolt and a housing. The housing has an opening to receive the bolt. The housing further has arranged therein a locking member for locking the bolt. The bolt comprises an elongated bolt body, a chamfered head end and a recess part in the elongated bolt body behind the chamfered head end. The chamfered head end is e.g. substantially hemispherical or with slanted slides. The locking member is rotatably provided inside the housing and arranged to rotate between a first orientation to lock the bolt in the housing and a second orientation different from the first orientation to release the lock from the housing. The locking member comprises a bended first end that fits behind the recess part of the bolt when the bolt is inserted into the opening of the housing and the locking member is rotated to the first orientation.

Thus, the locking member, which typically comprises a metal plate, can tilt to lock and unlock the bolt in the housing. In the locking position the bended end of the metal plate is located behind the head end of the bolt to thereby hold the bolt in position and prevent the bolt from being removed from the housing. The head end of the bolt is chamfered to ease insertion of the bolt into the housing and, when needed, lift the bended end of the locking member while inserting the bolt before being locked.

This design of the lock makes it possible to use relatively short bolts and small housings compared to known locks.

The embodiment of claim 2 advantageously enables the lock to be in locking state by default. In this state a bolt can be inserted into an empty housing due to the chamfered head end capable of lifting the bended end of the locking member while inserting the bolt before being locked.

The embodiment of claim 3 advantageously enables the bolt to be unlocked from the housing by applying a current to a coil and thus magnetizing the other end of the locking member, i.e. the end opposite of the bended end. Thus, an electromechanical lock is provided that can be steered by an external control system for providing the current.

The embodiments of claims 4 and 5 provide for alternative implementations of a tiltable locking member.

The embodiment of claim 6 advantageously enables detection of an inserted bolt. This detection can be used by an external system for e.g. triggering an alarm, logging locking/unlocking actions and/or control functions.

The embodiment of claim 7 advantageously enables the bolt and lock to be mounted on cabinets, showcases and drawers.

The embodiment of claim 8 advantageously enables the lock to be rotation symmetric in the direction of the elongated bolt body when inserted in the housing, thus resulting in the lock being usable on both left and right sides of cabinets, showcases and drawers.

The embodiments of claims 9-11 advantageously enables assembly of the elements within the housing such that they are inaccessible by users while maintaining the possibility to access the elements for e.g. maintenance purposes.

The embodiment of claim 11 advantageously enables the bolt to be conditionally unlocked, wherein the lock is programmable to unlock the bolt only if a programmed data pattern is detected. The data pattern is typically provided in a data signal originating from an external control system communicatively connected to the lock.

According to an aspect of the invention a security system is proposed. The security system comprises one or more locks according to any one of the claims 1-11. Each lock comprises a coil which, when being provided with a current, generates a magnetic force to a second end of the locking member different from the first end wherein the magnetic force exceeds the spring force resulting in the locking member to be rotated to the second orientation and the bolt to be removable from the housing. The security system further comprises a power supply configured to provide a current to the one or more locks for activating the coil. The security system further comprises an unlocking switch coupled between the power supply and the one or more locks. The security system further comprises an unlocking device configured to detect an authorized user causing the unlocking switch to providing the current to the one or more locks from the power supply to thereby unlock the one or more locks.

Thus, the locks can advantageously be used in a security system that controls the unlocking of the locks by authorizing a user before unlocking the lock. One or more locks can be simultaneously unlocked by an authorized user.

The embodiment of claim 13 advantageously enables various authorization technologies to be used for unlocking the locks.

The embodiment of claim 14 advantageously enables only one lock to be opened, after which all other locks are locked again. This ensures that unauthorized users cannot open a cupboard, showcase or drawer while the authorized user is opening another cupboard, showcase or drawer.

The embodiment of claim 15 advantageously enables locks to be opened only for a limited time period, e.g. 10 seconds, after authorizing a user. This ensures that locks do not remain open for example when the user forgets to open the cupboard, showcase or drawer after authorization.

Hereinafter, embodiments of the invention will be described in further detail. It should be appreciated, however, that these embodiments may not be construed as limiting the scope of protection for the present invention.

### BRIEF DESCRIPTION OF THE DRAWINGS

Aspects of the invention will be explained in greater detail by reference to exemplary embodiments of the invention shown in the drawings, in which:

FIG. 1 shows a lock of an exemplary embodiment of the invention;

FIGS. 2A-2D schematically show elements of a lock, including various orientations of a locking member, of an exemplary embodiment of the invention;

FIG. 3 schematically shows elements of a lock, including a switch, of an exemplary embodiment of the invention;

FIG. 4 shows elements of a lock, including a locking member and a spring, of an exemplary embodiment of the invention;

FIG. 4 schematically shows elements of a lock, including a spring and a coil for rotating a locking member, of an exemplary embodiment of the invention; and

FIG. 5 schematically shows a security system of an exemplary embodiment of the invention.

### DETAILED DESCRIPTION OF THE DRAWINGS

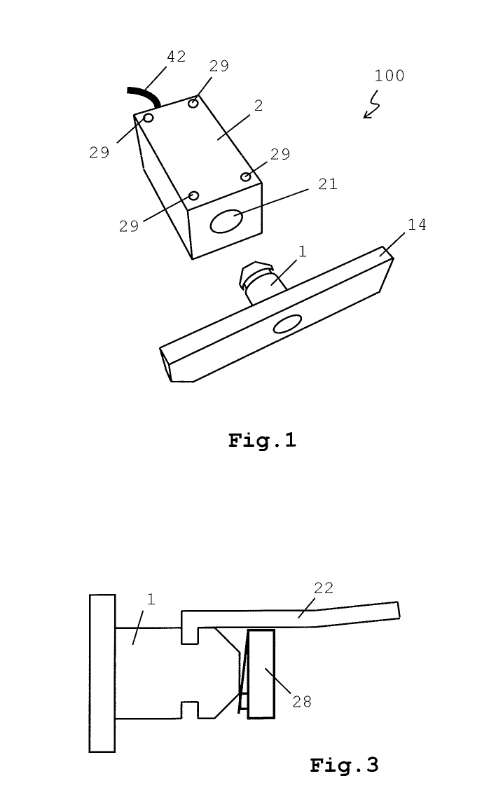

In FIG. 1 a three-dimensional view of the lock 100 is shown. The lock 100 has two parts: a bolt 1 that is typically attached to a moving part of a cupboard, showcase or drawer, and a housing 2 that is typically attached to a fixed part of the cupboard, showcase or drawer. The bolt 1 can be fixed to a base 14 of any form to simplify the attachment of the bolt 1. The housing 2 can be provided with one or more screw holes 29 to simplify the attachment of the housing. To lock the bolt 1 inside the housing 2 the bolt 1 is inserted through opening 21 of the housing, e.g. by closing a door of the cupboard, by closing a sliding door of a showcase or by closing a drawer.

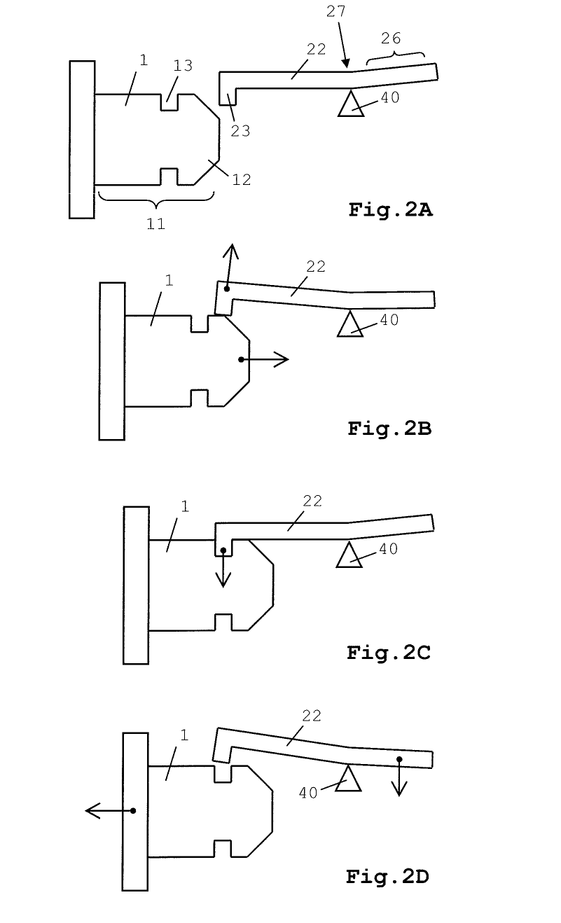

How the bolt 1 is locked and unlocked inside the housing 2 is schematically shown in FIGS. 2A-2D. The bolt 1 has an elongated body 11 with a chamfered head end 12. The head end 12 is chamfered to ease insertion of the bolt 1, as will be explained with FIG. 2B, and is e.g. substantially hemispherical or with slanted slides. Furthermore, the bolt 1 has a recess part 13 behind the head end 12. The recess part 13 is shaped such that a part of a locking member 22 can hold the head end 12 inside the housing 2 to thereby lock the bolt 1. This will be explained with FIG. 2C.

Inside the housing the locking member 22 is the element that effectively locks the bolt 1. The locking member 22, which is e.g. a metal plate, has a bended first end 23 that fits, at least partly, inside the recess part 13 to hold the bolt 1 in place when locked. The first end 23 is not necessarily bended in an acute angle, as shown in the figures, but may be curved and/or bended to another angle. The locking member 22 is rotatably provided inside the housing 2, which is abstractly indicated by the pivot element 40. Herein “rotate” and grammatical variants thereof includes “tilting”. It is to be understood that the pivot element 40 may not be physically part of the housing 2 and it merely indicates the rotatability of the locking member 22. In case the locking member 22 is straight, a pivot 40 in any form can be used to enable the rotation. Preferably the locking member 22 is bended at an inflection point 27 resulting in the locking member 22 having a kinked second end 26. A pivot 40 is then not needed as the locking member 22 can rotate around the inflection point 27. The maximum angle of rotation of the locking member 22 is typically small, i.e. just enough to lock and release the bolt 1, as will be explained.

In FIG. 2B the bolt 1 is being inserted into the housing 2, i.e. through the opening 21 shown in FIG. 1. The arrow pointing to the right indicates the movement of the bolt 1. The chamfered head 12 pushes the first end 23 up, which is indicated by the arrow pointing upwards, resulting in the locking member 22 to be tilted.

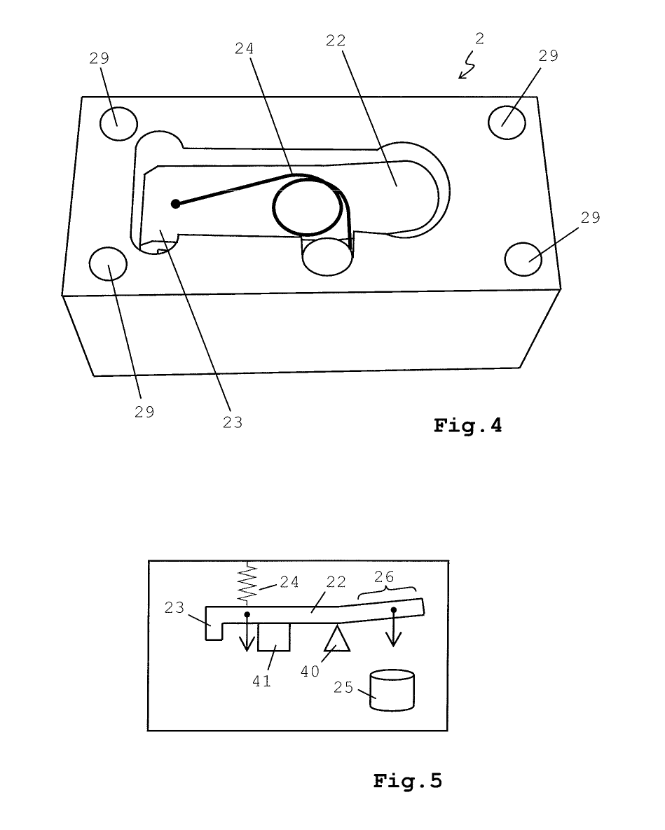

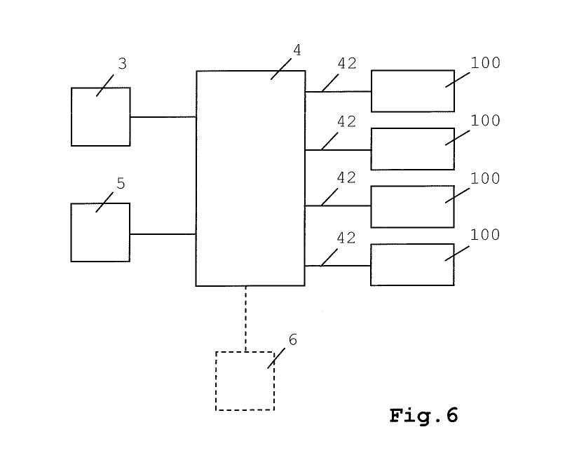

In FIG. 2C the bolt 1 is inserted into the housing 2 to the locking position. In this position the first end 23 of the locking member 22 snaps into the recess part 13 of the bolt 1, as indicated by the arrow, resulting in the bolt 1 being locked inside the housing 2. A spring 24 may be used to provide the required force to tilt the locking member 22 into the first orientation wherein the bolt 1 is locked, as will be explained with FIGS. 4 and 5.

The width of the recess part 13 is at least the thickness of the first end 23 of the locking member 2 for the first end 23 to fit behind the head end 12 of the bolt 1. It is possible that the recess part 13 is provided about the whole circumference of the elongated body 11 behind the head end 12.

To release the bolt 1 from the housing 2 the locking member 22 is tilted to a second orientation as shown in FIG. 2D. In this orientation the first end 23 is lifted by pulling the second end 26 of the locking member 2, as indicated by the arrow pointing downwards, to thereby enable the bolt 1 to be removed in the direction of the arrow pointing to the left. A coil 25 may be used to provide a magnetic force to the second end 26 to tilt the locking member 22 into the second orientation, as will be explained with FIG. 5.

It may be desirable to detect whether or not a bolt 1 is inserted into the housing 2. Hereto a switch 28 can be part of the housing 2, as schematically shown in FIG. 3. The switch 28 is e.g. in the form of a dip switch that switches between an on-state and an off-state depending on the bolt 1 pressing or depressing the switch 28. In FIG. 3 the bolt 1 is fully inserted into the housing 2 resulting in the locking member 22 locking the bolt 1 and the switch 28 being pressed to the on-state. The detection of the bolt 1 can e.g. be used to trigger an alarm when the bolt 1 is released from the lock 100 or to log opening and closing of the lock. Hereto the lock 100 is typically connected to a security system that received the state of the switch 28 and performs actions based on the received state. An example of a security system will be explained with FIG. 6.

Preferably the locking member 22 defaults to the first orientation wherein the bolt 1 would be locked when inserted into the housing 2. In FIG. 4 the housing 2 is shown where a cover is removed to access the locking member 22 inside the housing 2. Screw holes 29 are also shown. On top of the locking member 22 a spring 24 is positioned to provide spring force to the bended first end 23 of the locking member 23. In the example of FIG. 4 the spring is fixed to the housing 2 at one side of the locking member 22. Any other spring configurations can be used for providing spring force to the bended first end 23.

FIG. 5 schematically shows how forces can be applied to the locking member 22 for tilting into first and second orientations. As indicated by the left arrow, the spring 24 pushes the bended first end 23 of the locking member 22 to the first orientation wherein bolt 1 can be locked. The housing 2 typically supports the locking member 22 in the first orientation to prevent the locking member 22 from tilting too far and thereby making it impossible to insert the bolt 1. This is abstractly indicated by blocking element 41, which is to be understood to be a part of the housing 2. A coil 25 is located in the housing 2 at the second end 26 of the locking member 22. When a current is provided from an external power source to the coil 25, the coil 25 produces a magnetic field resulting in a magnetic force larger than the spring force and pulling the second end 26 of the locking member 22 to the second orientation wherein bolt 2 can be removed. When power is cut from the lock 100, the coil 25 is deactivated and the lock 100 snaps back into the locked position.

The housing 2 is typically provided with power through a cable 42, as shown in FIG. 1. The cable can also be used to communicate the state of the switch 28 to external systems.

The lock 100 can be used in a security system that conditionally unlocks the lock. FIG. 6 shows an example of a security system, wherein a power source 3 is coupled to the lock 100 through an unlocking switch 4. An unlocking device 5 is also connected to the unlocking switch 4. The unlocking device 5 is capable of detecting an identity to authorize a user to open the lock 100. Examples of unlocking devices 5 are tag readers, fingerprint readers or keypads for entering a code. The unlocking device 5 can be an intelligent device that performs the actual authorization and sends an unlocking command to the unlocking switch 4. In this case the unlocking switch 4 will provide a current from the power supply 3 to the lock 100 when the unlocking command is received. Alternatively the unlocking device 5 is an identity reader that sends the received identity to the unlocking switch 4. In this case the unlocking switch 4 performs the actual authorization before providing the current to the lock 100.

Optionally a computer system 6 is connected to the unlocking switch 4 to perform part or all of the authorization and/or control the unlocking switch 4. In the latter case more sophisticated authorization, e.g. based on the time of the day or a number of previous unlocking attempts, and monitoring of unlocking attempts can be performed.

Multiple locks 100 can be connected to the unlocking switch 4. Typically all locks 100 connected to a single switch 4 are unlocked simultaneously after authorization. To prevent others from opening locks while the authorized person is opening one of the locks, the unlocking switch 4 can be configured to close the locks 100 upon opening the first lock. The switch 28 can be used to detect the opening of the first lock. Other security measures can be configured in the unlocking switch 4, such as e.g. closing all locks 100 after a predetermined time period, e.g. 10 seconds, 1 minute or 30 minutes, to prevent the locks from remaining unlocked when the authorized user forgets to close the locks again.

It is to be understood that the unlocking device 5 can also be used to close the locks 100, e.g. by performing the same authorization when the locks 100 are in unlocked state.

The lock 100 is optionally provided with an electronic circuit 50 wherein a processor 52 is programmed with a data pattern to be recognized before unlocking the lock 100. The data pattern is transmitted from the unlocking switch 4 to the lock 100 in a data signal and may originate from a computer system 6 connected to the unlocking switch 4. This enables individual locks 100 connected to the unlocking switch 4 to be controlled instead of all at once. Moreover, an identity stored in the lock 100 can be read by the unlocking switch 4 or the computer system 6 for e.g. logging purposes.

1. A lock (100) comprising a bolt (1) and a housing (2) having an opening (21) to receive the bolt (1) and having arranged therein a locking member (22) for locking the bolt (1), wherein
the bolt comprises an elongated bolt body (11), a chamfered head end (12) and a recess part (13) in the elongated bolt body (11) behind the chamfered head end (12),
the locking member (22) is rotatably provided inside the housing (2) and arranged to rotate between a first orientation for locking the bolt (1) in the housing (2) and a second orientation different from the first orientation for releasing the bolt (1) from the housing (2), and
the locking member (22) comprises a bended first end (23) that fits in the recess part (13) of the bolt (1) when the bolt (1) is inserted into the opening (21) of the housing (2) and the locking member (22) is rotated to the first orientation.

2. The lock (100) according to claim 1, wherein the housing (2) further comprises a spring (24) applying a spring force to the locking member (22) to force the locking member (22) to the first orientation.

3. The lock (100) according to claim 1 or claim 2, wherein the housing (2) further comprises a coil (25) that, when being provided with a current, generates a magnetic force to a second end (26) of the locking member (22) different from the first end (23) wherein the magnetic force exceeds the spring force resulting in the locking member (22) to be rotated to the second orientation and the bolt (1) to be removable from the housing (2).

4. The lock (100) according to any one of the claims 1-3, wherein the locking member (22) is further bended at an inflection point (27) enabling the rotation of the locking member (22).

5. The lock (100) according to any one of the claims 1-4 wherein the housing (2) comprises a pivot (40) enabling the rotation of the locking member (22).

6. The lock (100) according to any one of the preceding claims, wherein the housing (2) further comprises a switch (28), wherein the switch (28) is in a first state when the bolt (1) is inserted in the housing (2) such that the bolt (1) is lockable by the locking member (22), and wherein the switch (28) is in a second state when the bolt (1) is unlocked and at least partially removed from the housing (2).

7. The lock (100) according to any one of the preceding claims, wherein the bolt (1) comprises a base (14) for attaching the bolt (1) to a movable part of a cabinet, a showcase or a drawer, and wherein the housing (2) comprises one or more screw holes (29) for attaching the housing (2) to a fixed part of the cabinet, the showcase or the drawer.

8. The lock (100) according to any one of the preceding claims, wherein the housing (2) is a rectangular three-dimensional housing comprising two opposite sides having an area smaller than the four other sides, and wherein the opening (21) is in the center of one of the two smaller sides.

9. The lock (100) according to claim 2 and claim 8, wherein the housing (2) further comprises a first recess at a first of the four other sides for fitting the locking member (22) and the spring (24), wherein the first of the four other sides is coverable by a first cover to secure the locking member (22) and the spring (24) inside the housing.

10. The lock (100) according to claim 3 and claim 9, wherein the housing (2) further comprises a second recess at a second of the four other sides opposite of the first of the four other sides for fitting the coil (25), wherein the second of the four other sides is coverable by a second cover to secure the coil (25) inside the housing (2).

11. The lock (100) according to claim 6 and claim 10, wherein the housing (2) further comprises a third recess at the second of the four other sides for fitting the switch (28), and wherein the second of the four other sides is coverable by the second cover to further secure the switch (28) inside the housing (2).

12. The lock (100) according to any one of the preceding claims, wherein the housing (2) further comprises an electronic circuit for conditionally providing the current to the coil (25), wherein the electronic circuit comprises a processor programmable to detect a data pattern in a data signal and to enable the current to the coil (25) if the data pattern is detected.

13. A security system comprising:
one or more locks (100) according to any one of the claims 1-12, each lock (100) comprising a coil (25) which, when being provided with a current, generates a magnetic force to a second end (26) of a locking member (22) different from a first end (23) resulting in the locking member (22) to be rotated to a second orientation and a bolt (1) to be removable from a housing (2);
a power supply (3) configured to provide a current to the one or more locks (100) for activating the coil (25);
an unlocking switch (4) coupled between the power supply (3) and the one or more locks (100); and
an unlocking device (5) configured to detect an authorized user causing the unlocking switch (4) to providing the current to the one or more locks (100) from the power supply (3) to thereby unlock the one or more locks (100).

14. The security system according to claim 13, wherein the unlocking device (5) is one of a tag reader for detecting an authorized tag, a fingerprint reader for detecting an authorized fingerprint, or a code reader for detecting an authorized code entered by a user.

15. The security system according to claim 13 or claim 14, wherein the unlocking switch (4) is configured to detect a removal of the bolt (1) from the housing (2) of a first lock and upon detection of the removal cutting the current to the one or more locks other than the first lock.

16. The security system according to any one of the claims 13-15, wherein the unlocking switch (4) is configured to cut the current to the one or more locks (100) after a predefined time period to lock the one or more locks (100) after unlocking.
